(19) United States
(12) Patent Application Publication
(10) Pub. No.: US 2011/0316429 A1
(43) Pub. Date: Dec. 29, 2011

(54) TRIAC-based light dimmer

(76) Inventor: Chia Chieh Liu, Taichung (TW)

(21) Appl. No.: 12/824,158

(22) Filed: Jun. 26, 2010

(51) Int. Cl. H05B 41/36

(52) U.S. Cl. 315/158

(57) ABSTRACT

A lamp system includes a dimmer comprising a temperature sensor, a TRIAC, and a rectifier; a lamp electrically connected to the TRIAC and mounted on the dimmer; and a controller electrically connected to the rectifier and comprising a processor electrically connected to a gate electrode of the TRIAC, a presence sensor for sensing presence of an object, a photosensor, and a time delay button. A first signal is generated by the temperature sensor when ambient temperature is over a predetermined value, the first signal is sent to the processor to generate a first trigger pulse, and the first trigger pulse is sent to the gate electrode of the TRIAC so that current flowing through the TRIAC to the lamp can be decreased.

### BACKGROUND OF THE INVENTION

1. Field of Invention

The invention relates to lamp control devices and more particularly to an improved TRIAC-based dimmer for a lamp (compact fluorescent lamp (CFL)).

2. Description of Related Art

Typically, a dimmer is a device used to vary the brightness of a lamp. By decreasing or increasing the Root Mean Square (RMS) voltage and hence the mean power to the lamp it is possible to vary the intensity of the light output.

A conventional dimmer, as a component of a lamp, is provided with a photosensor for sensing light intensity. Typically, the photosensor is implemented as a light dependent resistor which changes resistance according to light intensity.

However, the conventional dimmers are not durable and have other drawbacks. Thus, the need for improvement still exists.

### SUMMARY OF THE INVENTION

It is therefore one object of the invention to provide a lamp system comprising dimming means comprising a temperature sensor, a TRIAC, and a full wave rectifier for converting AC into DC to be consumed by the TRIAC and the temperature sensor; a lamp electrically connected to the TRIAC and mounted on the dimming means; and control means electrically connected to the full wave rectifier and comprising a processor electrically connected to a gate electrode of the TRIAC, a presence sensor for sensing presence of an object, a photosensor, and a time delay button, wherein a first signal is generated by the temperature sensor when ambient temperature is over a predetermined value, the first signal is sent to the processor to generate a first trigger pulse, and the first trigger pulse is sent to the gate electrode of the TRIAC so that current flowing through the TRIAC to the lamp can be decreased; and wherein a second signal is generated by both the presence sensor and the photosensor when no object is detected, the second signal is sent to the processor to generate a second trigger pulse, and the second trigger pulse is sent to the gate electrode of the TRIAC after a predetermined amount of time set by the time delay button so that current flowing through the TRIAC to the lamp can be decreased.

The above and other objects, features and advantages of the invention will become apparent from the following detailed description taken with the accompanying drawings.

### BRIEF DESCRIPTION OF THE DRAWINGS

FIG. 1 is an exploded perspective view of a lamp system according to the invention;

FIG. 2 is a block diagram of the lamp system;

FIG. 3 is a detailed schematic of the TRIAC and associated components;

FIG. 4 plots voltage versus time for the TRIAC when it is turned on normally;

FIG. 5 plots voltage versus time for the TRIAC in a high temperature environment; and

FIG. 6 plots voltage versus time for the TRIAC when no person is present in a room.

### DETAILED DESCRIPTION OF THE INVENTION

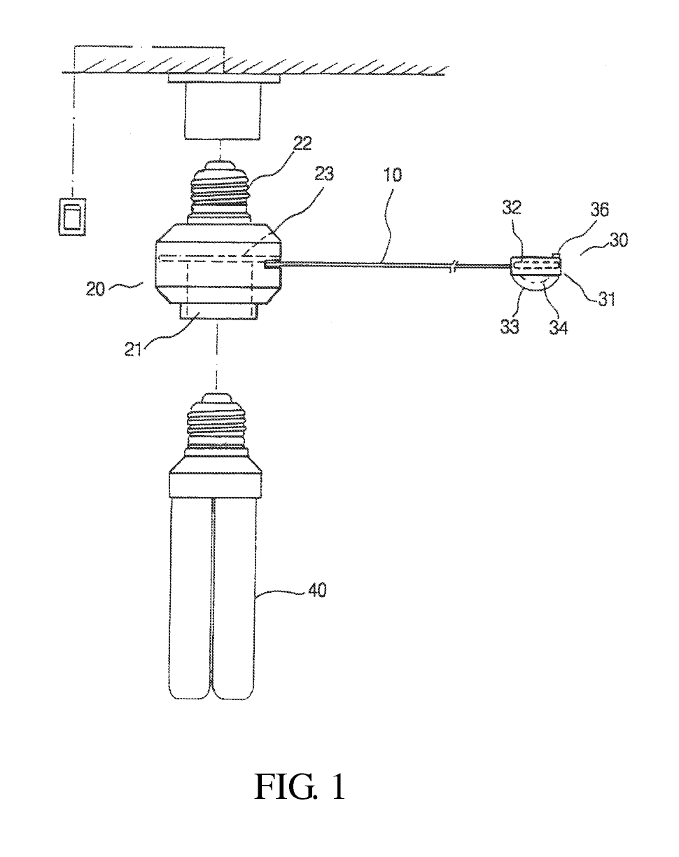

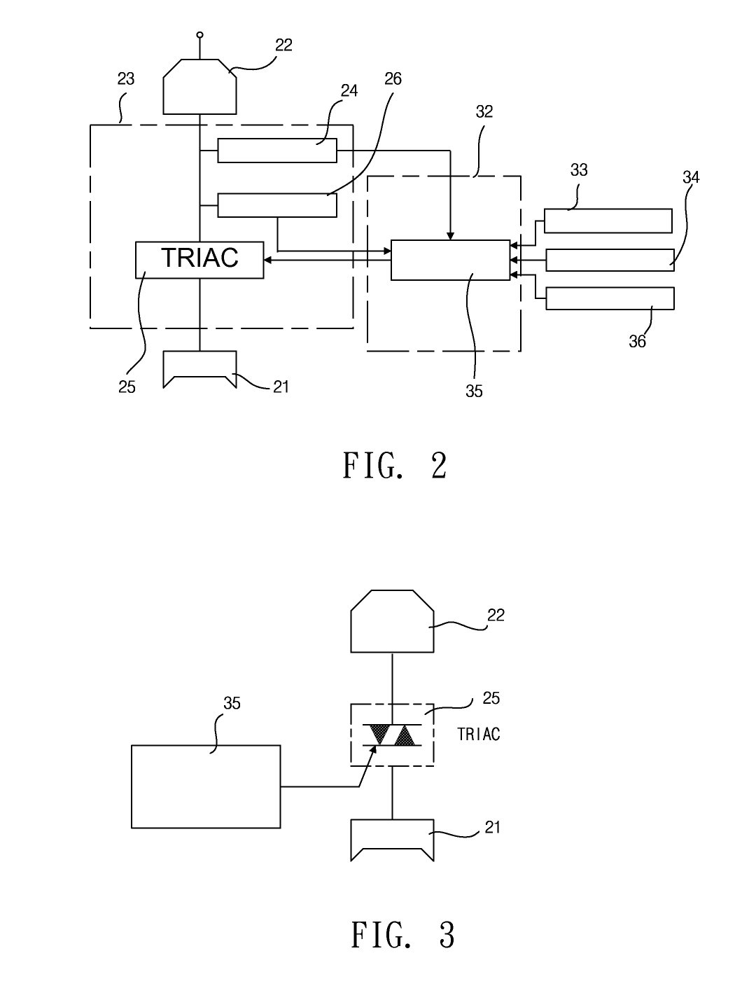

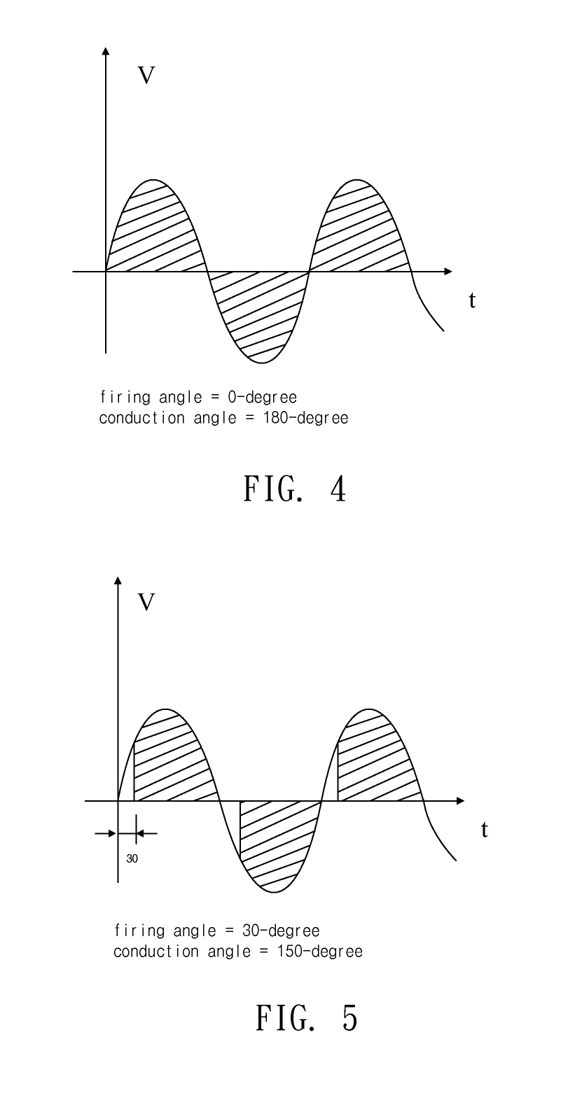

Referring to FIGS. 1 to 6, a lamp system of the invention comprises the following components as discussed in detail below.

A lamp (e.g., CFL) 40 is provided.

A dimmer 20 comprises a socket 21 adapted to threadedly secure to a base of the lamp 40, a base 22 adapted to threadedly secure to a socket of a light fixture for getting alternating current (AC) therefrom, and a printed circuit board (PCB) 23 comprising a full wave rectifier 24 for converting AC into DC (direct current) to be consumed by the dimmer and other components, a temperature sensor 26 for sensing temperature, and a Triode for Alternating Current (TRIAC) 25 all mounted thereon. The TRIAC 25 is electrically connected to the lamp 40 via the socket 21 in one electrode and to the base 22 in the other electrode.

A controller 30 is electrically connected to the dimmer 20 via a cord 10 and comprises a housing 31, a PCB 32 provided in the housing 31 and powered by the rectifier 24, a processor 35 provided on the PCB 32, a presence sensor 33 provided on the housing 31 for sensing the presence of human body, a photosensor 34 provided on the PCB 32, and a programmable time delay button 36 provided on top of the housing 31.

The processor 35 acts as a gate electrode of the TRIAC 25. In detail, the TRIAC 25 can be triggered by either a positive or a negative voltage applied to the processor 35. Once triggered, the TRIAC 25 continues to conduct until the current through it drops below a certain threshold value, the holding current.

Signals from the temperature sensor 26, the presence sensor 33, the photosensor 34, and the time delay button 36 are transmitted to the processor 35. In detail, in one embodiment a signal will be generated by the temperature sensor 26 when ambient temperature is over a predetermined safety value (i.e., high light intensity). The signal is sent to the processor 35 to generate a trigger pulse which is in turn sent to the gate electrode of the TRIAC 25 so as to control the percentage of current (i.e., current decrease) that flows through the TRIAC 25 to the load (i.e., the lamp) 40. This can be best illustrated in FIG. 5 where a firing angle of 30-degree (i.e., a short lagging) and a conduction angle of 150-degree are shown. As a result, the lamp 40 dims. This can also protect components of the dimmer 20 (e.g., the PCB 23).

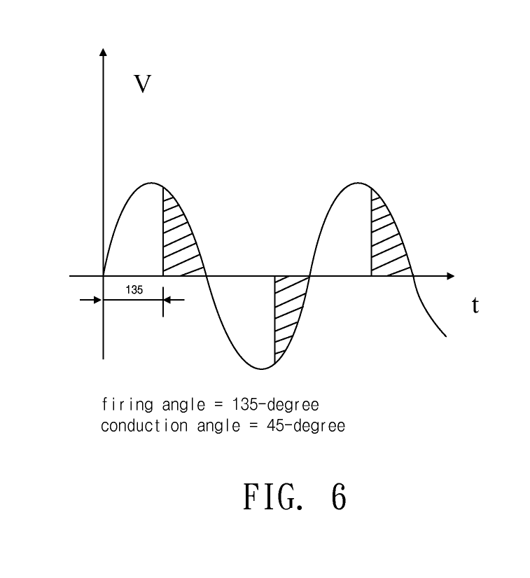

In the other embodiment (e.g., in a room), a signal will be generated by both the presence sensor 33 and the photosensor 34 when no human body is detected (i.e., a person leaving the room). The signal is sent to the processor 35 to generate a trigger pulse which is in turn sent to the gate electrode of the TRIAC 25 after a time delay (e.g., three minutes) set by the time delay button 36 so as to control the percentage of current (i.e., current drop) that flows through the TRIAC 25 to the load (i.e., the lamp 40). This can be best illustrated in FIG. 6 where a firing angle of 135-degree (i.e., a long lagging) and a conduction angle of 45-degree are shown. As a result, the lamp 40 dims. This is similar to the function of night light.

While the invention has been described in terms of preferred embodiments, those skilled in the art will recognize that the invention can be practiced with modifications within the spirit and scope of the appended claims.

What is claimed is:

1. A lamp system comprising:
dimming means comprising a temperature sensor, a TRIAC, and a full wave rectifier for converting AC into DC to be consumed by the TRIAC and the temperature sensor;
a lamp electrically connected to the TRIAC and mounted on the dimming means; and
control means electrically connected to the full wave rectifier and comprising a processor electrically connected to a gate electrode of the TRIAC, a presence sensor for sensing presence of an object, a photosensor, and a time delay button,
wherein a first signal is generated by the temperature sensor when ambient temperature is over a predetermined value, the first signal is sent to the processor to generate a first trigger pulse, and the first trigger pulse is sent to the gate electrode of the TRIAC so that current flowing through the TRIAC to the lamp can be decreased; and
wherein a second signal is generated by both the presence sensor and the photosensor when no object is detected, the second signal is sent to the processor to generate a second trigger pulse, and the second trigger pulse is sent to the gate electrode of the TRIAC after a predetermined amount of time set by the time delay button so that current flowing through the TRIAC to the lamp can be decreased.

2. The lamp system of claim 1, wherein the time delay button is programmable.

3. The lamp system of claim 1, wherein the lamp is a compact fluorescent lamp (CFL).
